(19) United States
(12) Patent Application Publication
(10) Pub. No.: US 2008/0036169 A1
(43) Pub. Date: Feb. 14, 2008

(54) User-Propelled Wheeled Vehicles

(76) Inventors: Enda Thomas, Enfield (GB); Ben Farrin, Waltham Cross (GB); Maurice Martin, London (GB)

Correspondence Address: YOUNG & THOMPSON, 745 SOUTH 23RD STREET, 2ND FLOOR, ARLINGTON, VA, 22202, US

(21) Appl. No.: 11/632,274

(22) PCT Filed: Jan. 14, 2005
(86) PCT No.: PCT/GB05/00111

§ 371 Date: May 15, 2007

(30) Foreign Application Priority Data
Jul. 14, 2004 (GB) 3018084
Jul. 14, 2004 (GB) 3018085
Jul. 14, 2004 (GB) 3018086
Jul. 21, 2004 (GB) 3018169
Jul. 21, 2004 (GB) 3018170
Jul. 22, 2004 (GB) 3018189
Jul. 22, 2004 (GB) 3018190
Sep. 3, 2004 (GB) 3017338
Sep. 7, 2004 (GB) 3018663
Nov. 5, 2004 (GB) 0424503.1
Nov. 5, 2004 (GB) 0424504.9

(51) Int. Cl. B62M 1/16

(52) U.S. Cl. 280/240

(57) ABSTRACT

A vehicle (100) is propelled by using the handlebar column (90) as a lever that can be pivoted to-and-fro and that also has a dive end or crank (50) which directly engages with the front wheel (101), whereby the front wheel is moved forwards in the rearword stroke. With a minimum of driving parts, the vehicle is reliable and durable. In addition vehicles according to this invention are stainable because they use no fuel. The drive lever (90) may be moved by hand or arm. Such vehicles may be two- or three-wheeled scooters for on-road or off-road use. The vehicle has a one-direction gear (55) to operate to allow angular driven movement of the driven wheel only during rearward movement of the lever, so that during forward movement of the lever the front wheel (101) can turn forwards freely.

### TECHNICAL FIELD

The present invention relates to improvements in user-propelled wheeled vehicles.

### BACKGROUND OF THE INVENTION

User-propelled wheeled vehicles are known having a lever pivoted on a frame and connected to the rear wheel of the vehicle via elongate link members, a looped drive chain and wheel sprocket. Such propelling devices are cumbersome, unreliable and difficult to maintain owing to the complex linkages.

An object of this invention is to improve user-propelled wheeled vehicles.

### SUMMARY OF THE INVENTION

According to the invention we propose a user-propelled wheeled vehicle comprising at least one driven wheel and a device for driving the wheel, the driving device comprising a drive lever, which is pivotable between its ends on the vehicle, the lever having:

a user-operable first portion, which is arcuately-reciprocatable forwardly and rearwardly of the vehicle by a user, and a second, drive portion, which is arcuately-reciprocatable with the first portion to angularly move the driven wheel forwards, thereby to propel the vehicle forwards.

The present applicants have appreciated that it is beneficial to use repeated lever action directly on a driven wheel so that the vehicle may be propelled forwards and travel may be obtained.

Throughout this specification the term “arcuately-reciprocatable” means repeated to-and-fro angular movement about a pivot.

The drive device allows direct transmission of power to the wheel from the lever and the vehicle may be propelled forwards effectively. With a minimum of driving parts, the vehicle is reliable and durable. In addition vehicles according to this invention are sustainable because they use no fuel.

The vehicle may comprise a front wheel and a rear wheel, wherein the front wheel is the driven wheel. Driving the front wheel propels the vehicle forwards highly effectively. The drive lever may be moved by hand or arm. Such vehicles may include two- or three-wheeled scooters for on-road or off-road use.

The vehicle may include a device disposed between the drive end of the lever and the driven wheel to drivingly engage the drive end of the lever with the driven wheel.

The drive end of the lever may comprise an arcuate portion including a first engaging part and the driven wheel may include a second engaging part for co-operating with the first engaging part so as to drive the driven wheel.

The vehicle may further include a device to stop driving engagement between the drive lever and the driven wheel and avoid any rearward movement of the driven wheel during the arcuate reciprocation of the lever.

The stop device may comprise a one-direction-of-rotation gear, which may be a freewheel gear. This may be single speed. The stop device may comprise a one-direction gear to operate to allow angular movement of the driven wheel only during rearward movement of the lever, so that during forward movement of the lever the driven wheel can turn forwards freely.

The user-operable first portion may also act as a handlebar column for the vehicle and the second portion of the lever may be provided by a lower rigid member off-set from the line of the handlebar column.

The handlebar column may have a transverse portion at its lower end, which transverse portion is supported on the vehicle to provide the pivotal movement of the lever action.

Furthermore:

The handlebar column may be supported on the vehicle via a support device having at least one strut connected to the driven wheel and a steering arm connected to the vehicle, and the arm may be pivotally mounted on the vehicle for steering the vehicle sideways using the handlebar column. The support arm may extend upwardly and forwardly of the vehicle. The transverse portion of the lever may be pivotally supported on the vehicle via the support device.

The lower rigid member may be elongate and connect the arcuate drive portion to the transverse portion of the lever. There may be a pair of said elongate connecting members, each extending from an opposite end of the arcuate drive portion.

The wheeled vehicle of the invention may, for instance be a stand-on or ride-on scooter. Such scooters can be used as a means of transport, exercise or recreation. The scooters may be made from lightweight, strong, rigid material, such as aluminium alloy, titanium or carbon fibre. Scooters according to the invention may be foldable for carrying or storage. Such vehicles can be continuously propelled forwards over considerable distances.

Another form the vehicle may take is a wheelchair for infirm or disabled people as a seat may be provided and the vehicle may be operated by a seated user.

According to another aspect of the invention, we propose According to the present invention there is provided a scooter or tricycle wherein the handlebars or handlebar pole is pivoted and fitted with a crank and the front wheel is fitted with a sprocket. The arrangement is such when the handlebar pole is pulled back or inwards the crank turns the sprocket which propels the front wheel forward.

According to yet another aspect of the invention, we also propose a wheelchair wherein the handlebars or handlebar pole is pivoted and fitted with a crank and the front wheel is fitted with a sprocket. The arrangement is such when the handlebar pole is pulled back or inwards the crank turns the sprocket which propels the front wheel forward.

### BRIEF DESCRIPTION OF THE DRAWINGS

Embodiments of this invention are now described, by way of example, with reference to the drawings, in which:

FIG. 1 is a diagrammatic perspective view of a first embodiment of a user-propelled scooter according to the invention, showing the vehicle in one position;

FIG. 2 is a close-up diagrammatic front view showing details of the front wheel of the vehicle of FIG. 1;

FIG. 3 is a diagrammatic side view of the vehicle of FIGS. 1 and 2, showing the vehicle in a second position;

FIG. 4 is a schematic view of a sprocket wheel employed in the embodiments of the invention;

FIG. 5 is a diagrammatic view of a support arm and side struts employed in the embodiments of the invention;

FIG. 6 is a diagrammatic perspective view of a second embodiment of a user-propelled vehicle according to the invention;

FIG. 7 is a close up diagrammatic front view, similar to FIG. 2, showing details of the front wheel of the vehicle of FIG. 6;

FIG. 8 shows a side view of a third embodiment of a user-propelled vehicle according to the invention;

FIG. 9 is another close up diagrammatic front view, similar to FIG. 2, showing details of the front wheel of the vehicle of FIG. 8;

FIG. 10 is a diagrammatic perspective view of a fourth embodiment of user-propelled wheelchair according to the invention; and

FIG. 11 is a flow diagram of a method of operating user-propelled wheeled vehicles according to this invention.

### BEST MODES OF CARRYING OUT THE INVENTION

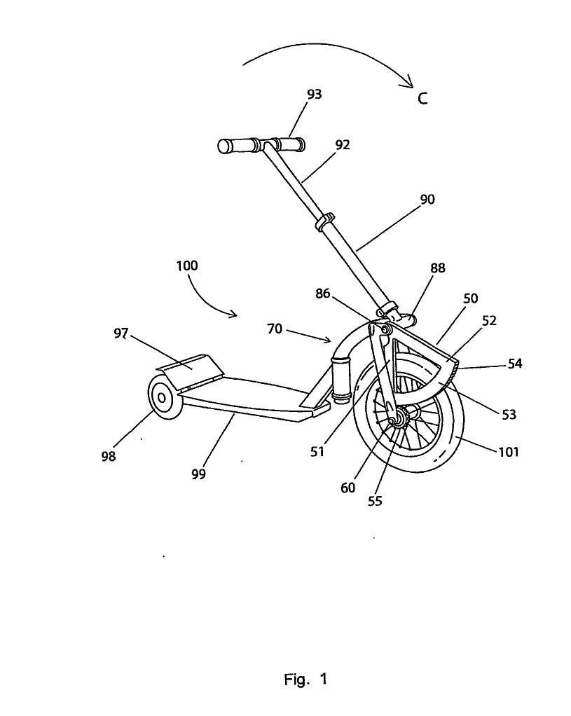

FIG. 1 of the drawings shows a three-wheeled scooter (100). The scooter has a driven 12.5″ front wheel (101), a footboard platform (99), a pair of 140 mm rear wheels (95) at the back of the footboard, a sprung rear wheel brake plate (97), a telescopic Handlebar column (90) including a pole (92) having at the top a pair of handlebars (93).

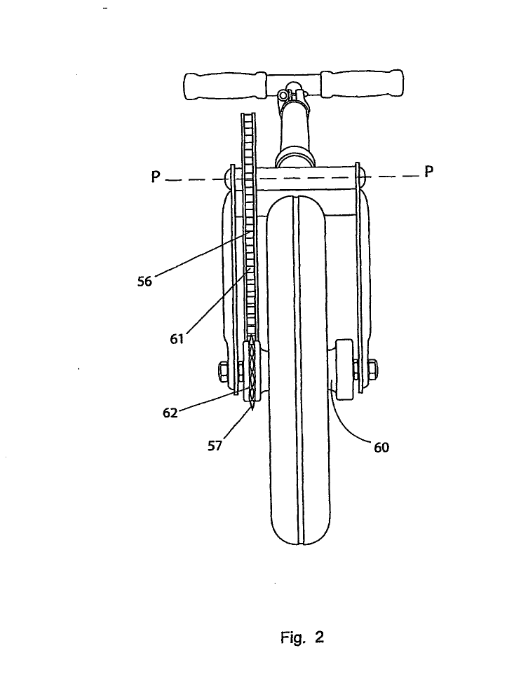

Attached to the lower end of the Handlebar column is a crank (50) which meshes with a 7 cm diameter sprocket wheel (55) co-axially mounted on the axle (60) of the front wheel (101). This has an outer annular sprocket wheel (62) with identical, regularly spaced teeth (61) (see FIGS. 2 and) on a concentric inner annular wheel which houses an internal ratchet and pawl stop device (not shown) to engage with the outer wheel. The stop device allows the outer wheel to only rotate in the forwards direction.

A single speed, freewheel gear of the type supplied by Lovson Exports Ltd under model no. LCS-110 can function as the sprocket wheel (55). This is drivable forwards but allows the front wheel to rotate freely when not being driven forwards.

The crank has angularly-spaced first and second rigid elongate arm members (51, 52), which are integral with an arcuate rigid member (53). The crank is fastened for angular movement at its upper end simultaneously with the Handlebar column (90) on a transverse fixed socket-headed bolt (86). The telescopic handlebar column (90) has at its lower end a T-piece with a transverse portion (88), the bolt (86) passing through this.

Thus, the crank moves together with the Handlebar column and they define a drive lever for the front wheel of the scooter. The rearward arm (52) is essential for transferring the force whereas the forward arm (53) is optional and assists in rigidity. The crank and handlebar column are made from Aluminium alloy.

The underside (54) of the arcuate portion (53) has a groove (61) in which is screw-fastened under spring tension a line of bicycle chain (56), which is located so as to mesh with the sprockets (57) of the outer wheel (62). When the handlebar column (90) is pivoted rearwards the crank will mesh with the sprocket wheel to move it forwards, thereby propelling the scooter forwards about 1 metre for this embodiment.

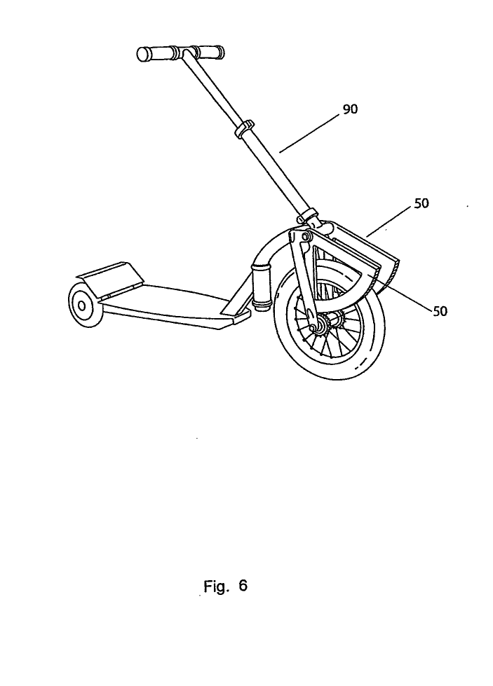

The Handlebar column (90) is mounted on the scooter via a support device (80), having a tubular steering arm (82) with a cross-piece (83) at its upper end, as shown in FIG. 5. The lower end (87) of the arm is received in a sleeve (84) housing spaced bearings for angular sideways steering of the scooter. The sleeve is fixed to the platform by a cross-member (81). The arm and struts are made of steel.

Extending downwards at each end of the cross-piece is a pair of spaced, side struts (85), fixed at their lower ends to the front wheel axle as supports.

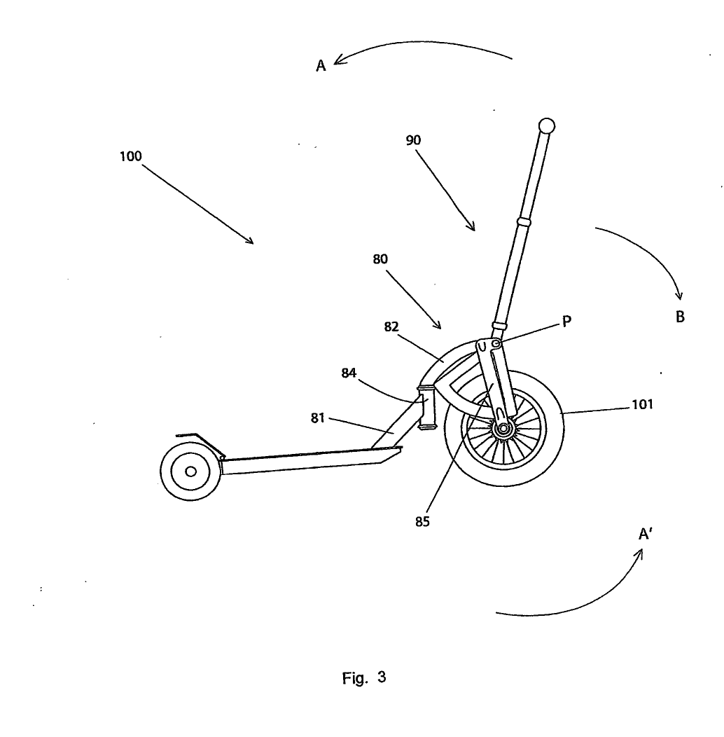

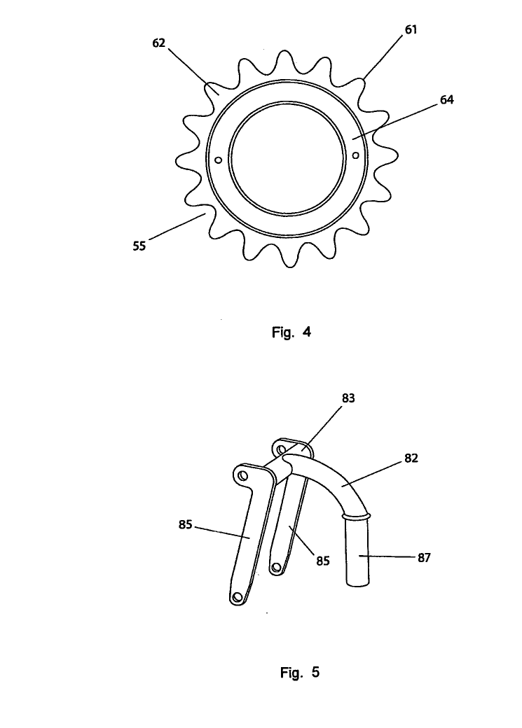

The arrangement is such that when the handlebar column (90) pulled back as shown in FIG. 1 and illustrated by arrow A in FIG. 3, the crank (50) meshes with the sprocket wheel (55) on the front wheel (101) and turns the front wheel forward, illustrated by arrow B. When the handlebar column (90) is pushed forward, as shown in FIG. 4 and illustrated by arrow C, the crank (50) freewheels on the sprocket wheel (55) on the front wheel (101).

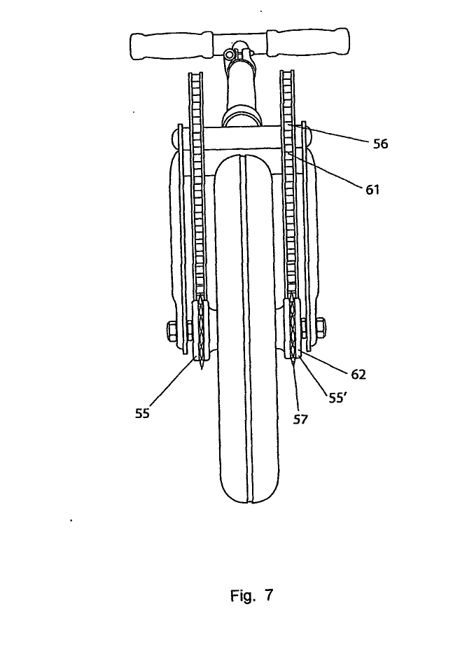

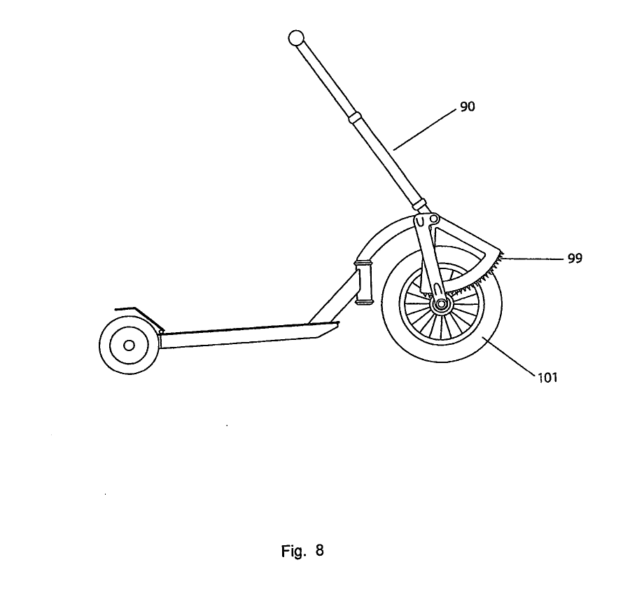

FIGS. 6 and 7 show a second embodiment of the invention in which a second crank (50′) identical to the first is mounted on an additional sprocket (55′) on the other side of the front wheel. Sprocket (55) is a right hand drive sprocket and sprocket (55′) is a left hand version of the same sprocket. The other parts are the same as in the first embodiment.

The drive apparatus operates in the same way as in the first embodiment. The additional crank and sprocket provide extra stability.

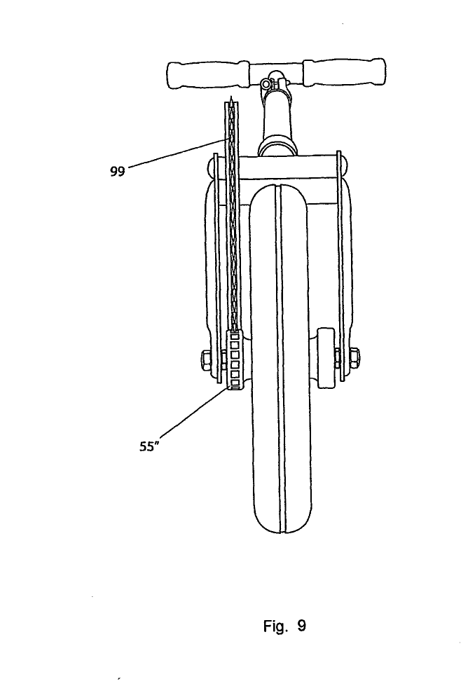

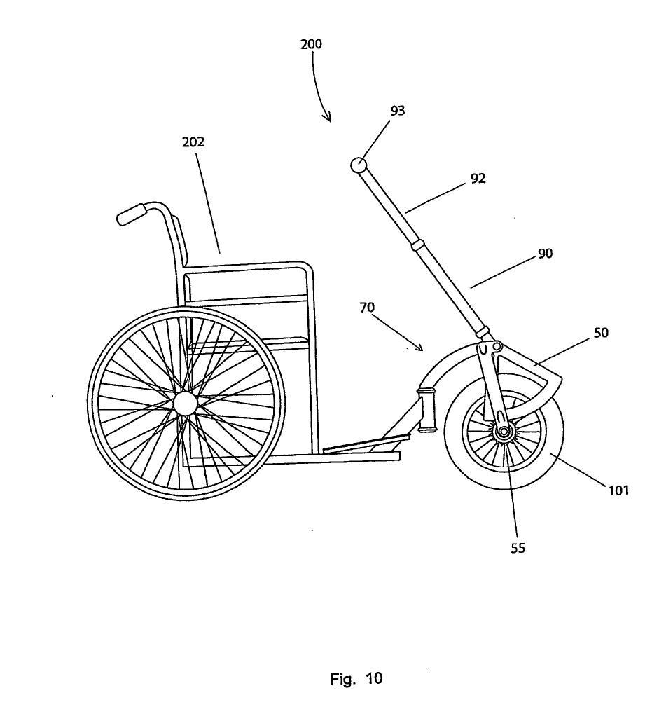

FIGS. 8 and 9 show a third embodiment of the invention in which the groove and chain on the crank are replaced by an arc of regularly spaced identical teeth (99) disposed to mesh with a series of regularly-spaced recesses around the outside of the sprocket (55″). The crank operates in the same way as before.

As a further embodiment, a wheelchair (200) according to the invention is shown in FIG. 10. This has the same drive lever apparatus and operation of the front wheel (101) as in the first embodiment. A chair (202) for an infirm or disabled user is fixed to the platform and a user is able to push the handlebar column to and fro from a seated position.

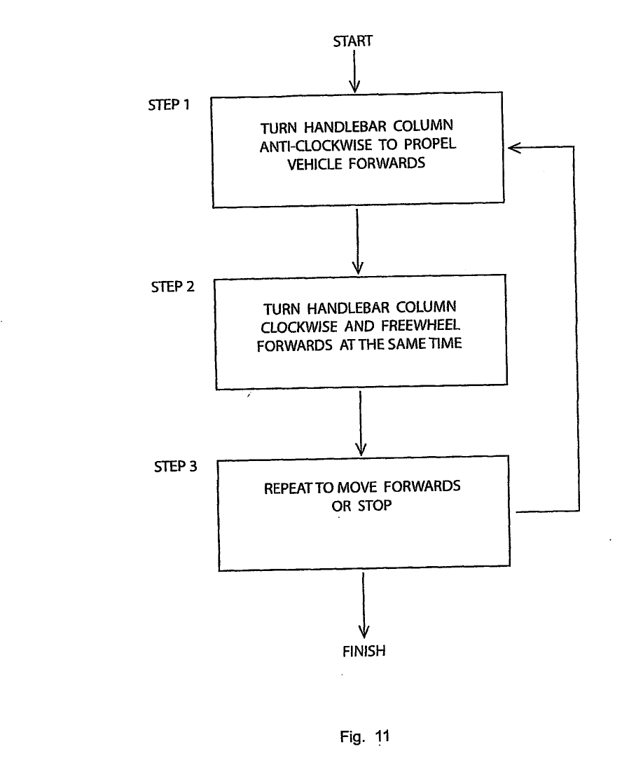

A summary of the operation of the vehicle of the invention is shown in the flow diagram of FIG. 11. The steps of operation by users are as follows:

1) Pull the handlebar column back towards the user in the clockwise direction of Arrow A. This turns the column arcuately anti-clockwise in the direction of arrow B and the handlebar column pivots about the axis P shown in FIGS. 2 and 3. The crank is by the same action turned arcuately anti-clockwise i.e. in the direction of arrow A′ (the same direction as A).

The crank, engaging with the one-direction gear, turns it arcuately clockwise i.e. in the direction of arrow B shown in FIG. 3, which results in the front wheel being driven forwards. If the crank is moved to its clockwise extreme, the wheel moves forwards a certain amount, which can be repeated each time the lever is moved in this way. If the crank is turned a lesser amount, the distance the wheel is turned will decrease.

2) After step 1, the handlebar column is pushed forwards in the direction of arrow B and owing to the one-direction gear, the front wheel is allowed to rotate forwards freely, while the crank moves anti-clockwise over the teeth.

The crank may be moved to its extreme anti-clockwise position or to an intermediate position, after which step 1) is repeated as required.

3) The two steps may be repeated so as to travel along by propelling the vehicle forwards. This is an effective means of transport, exercise or recreation.

The present invention may be embodied in other specific forms without departing from the spirit or essential characteristics thereof. Therefore, the presently discussed embodiments are considered to be illustrative and not restrictive, the scope of the invention being indicated by the claims.

1-15. (canceled)

16. A user-propelled wheeled vehicle comprising at least one driven wheel and a device for driving the wheel, the drive device comprising a drive lever, which is arcuately-reciprocatable forwardly and rearwardly by a user, the lever having:
a pivot axis between its ends on the vehicle, a user-operable portion on one side of the pivot, and a drive portion on the other side of the pivot axis, the drive portion being movable about the same pivot axis as the user-operable portion so as to be arcuately-reciprocatable by and with the first portion to angularly move the driven wheel forwards and thereby to propel the vehicle forwards.

17. A user-propelled wheeled vehicle as claimed in claim 16, wherein the drive portion of the lever comprises an arcuate drive member including a first engaging part and the driven wheel including a second engaging part for co-operating with the first engaging part so as to drive the driven wheel.

18. A user-propelled wheeled vehicle as claimed in claim 16, further comprising an elongate member connecting the arcuate drive end with the user-operable portion.

19. A user-propelled wheeled vehicle as claimed in claim 16, wherein the drive portion is angularly movable simultaneously with the user-operable portion.

20. A vehicle according to claim 16, comprising a front wheel and a rear wheel, wherein the front wheel is the driven wheel.

21. A vehicle according to claim 16, including a device between the drive end of the lever and the driven wheel to drivingly engage the drive end of the lever with the driven wheel.

22. A vehicle according to claim 21, wherein the device between the drive end of the lever and the driven wheel to drivingly engage the drive end of the lever with the driven wheel, comprises a line of tensioned bicycle chain.

23. A vehicle according to claim 21, including a device to stop driving engagement between the drive lever and the driven wheel and avoid any rearward movement of the driven wheel during arcuate reciprocation of the lever.

24. A vehicle according to claim 23, wherein the stop device comprises a one-direction gear.

25. A vehicle according to claim 24, wherein the stop device comprises a freewheel gear.

26. A vehicle according to claim 24, wherein the stop device comprises a one-direction gear to operate to allow angular driven movement of the driven wheel only during rearward movement of the lever, so that during forward movement of the lever the driven wheel can turn forwards freely.

27. A vehicle according to claim 16, wherein the user-operable first portion is also a handlebar column of the vehicle.

28. A vehicle according to claim 27, wherein the drive lever also includes a lower portion including the drive end, which is off-set from the line of the handlebar column.

29. A vehicle according to claim 27, wherein the handlebar column includes a transverse portion at its lower end, the transverse portion being supported on the vehicle for pivotal movement of the lever.

30. A vehicle according to claim 27, wherein the handlebar column is supported on the vehicle via a support device comprising at least one strut connected to the driven wheel and an arm connected to the vehicle, wherein the arm is pivotally mounted on the vehicle for steering the vehicle sideways.

31. A vehicle according to claim 16, wherein the vehicle is a scooter or a wheelchair.
